(19) United States
(12) Patent Application Publication
(10) Pub. No.: US 2011/0314660 A1
(43) Pub. Date: Dec. 29, 2011

(54) SPIN WELD METHOD OF MANUFACTURING INDUCTION ROTORS

(75) Inventors: Timothy J. Alfermann, Noblesville, IN (US); Arthur L. McGrew, JR., Indianapolis, IN (US); Robert T. Szymanski, St. Clair Township, MI (US); Blair E. Carlson, Ann Arbor, MI (US); Mark T. Hall, Troy, MI (US)

(73) Assignee: GM GLOBAL TECHNOLOGIES OPERATIONS, INC., Detroit, MI (US)

(21) Appl. No.: 12/823,292

(22) Filed: Jun. 25, 2010

(51) Int. Cl. H02K 15/09

(52) U.S. Cl. 29/598

(57) ABSTRACT

A method of manufacturing an electric motor includes stacking a plurality of laminate layers to form a rotor stack. A plurality of conductor bars are inserted into a respective one of a plurality of rotor slots defined by the rotor stack, such that each of the plurality of conductor bars protrudes from the axial ends of the rotor stack. End pieces for the electric motor are rotated relative to the plurality of conductor bars to weld the end pieces to the conductor bars.

### TECHNICAL FIELD

The present invention relates to a rotor for an electric motor.

### BACKGROUND OF THE INVENTION

Electric motors include rotor assemblies which have conductor bars for the motor. A rotor stack for the rotor assembly includes teeth that extend radially inward from the rotor stack. The conductor bars are inserted into slots defined by the spaced apart rotor teeth. The conductor bars axially protrude from the rotor slots at either end of the rotor stack. End pieces are fixed to the protruding portions of the conductor bars at both ends of the rotor stack.

Typically, the end pieces and conductor bars are die cast into the ends of the rotor stack. Die casting the rotor is advantageous for producing high volumes, but available materials that provide the conductivity required by the electric motor tend to stick to the die, which results in wear on the die. These materials are prone to hot cracking during casting as well.

Tungsten inert gas (TIG) welding is another common method of securing the end pieces to the conductor bars. However, TIG welding is a time consuming process and is not typically used for high volume products. Additionally, controlling the depth of heat penetration to ensure proper strength and conductivity of the weld joint can be an issue.

Brazing is another common method of securing the end pieces to the conductor bars if the material, such as copper, lends itself to this method. However, brazing can also be a time consuming process and is only available for a limited selection of materials.

### SUMMARY OF THE INVENTION

A method of manufacturing an electric motor includes stacking a plurality of laminate layers to form a rotor stack. The rotor stack defines a plurality of rotor slots. A plurality of conductor bars are inserted into the plurality of rotors slots such that each of the plurality of conductor bars protrudes from the axial ends of the rotor stack. One of the rotor stack or end pieces for the electric motor are rotated to weld the end pieces to the axial ends of the plurality of conductor bars.

A method of securing an end piece to a plurality of conductor bars for an electric motor includes securing a rotor stack having a plurality of axially protruding conductor bars to at least a first component of a weld fixture. A first end piece is then secured to at least a second component of the weld fixture, such that the first end piece abuts the axial end of the plurality of conductor bars. The first component or the second component is rotated relative to the other and axial force is applied by the weld fixture such that a friction weld bond is formed between the first end piece and the plurality of conductor bars.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic end view of a rotor and a stator assembly for an electric motor having a cut away illustrating a partial portion of the rotor;

FIG. 2 is a schematic perspective view of a rotor stack for the electric motor of FIG. 1;

FIG. 3 is a schematic perspective view of the rotor stack and conductors for the electric motor of FIGS. 1 and 2;

FIG. 4 is a schematic end view of a first embodiment of a spin weld fixture for securing the end pieces to the electric motor of FIGS. 1-3; and

FIG. 5 is a schematic cross-sectional view of a portion of a weld fixture and the rotor stack, conductors and an end piece for the electric motor of FIGS. 1-4 taken along section 5-5 in FIG. 4.

### DESCRIPTION OF THE PREFERRED EMBODIMENTS

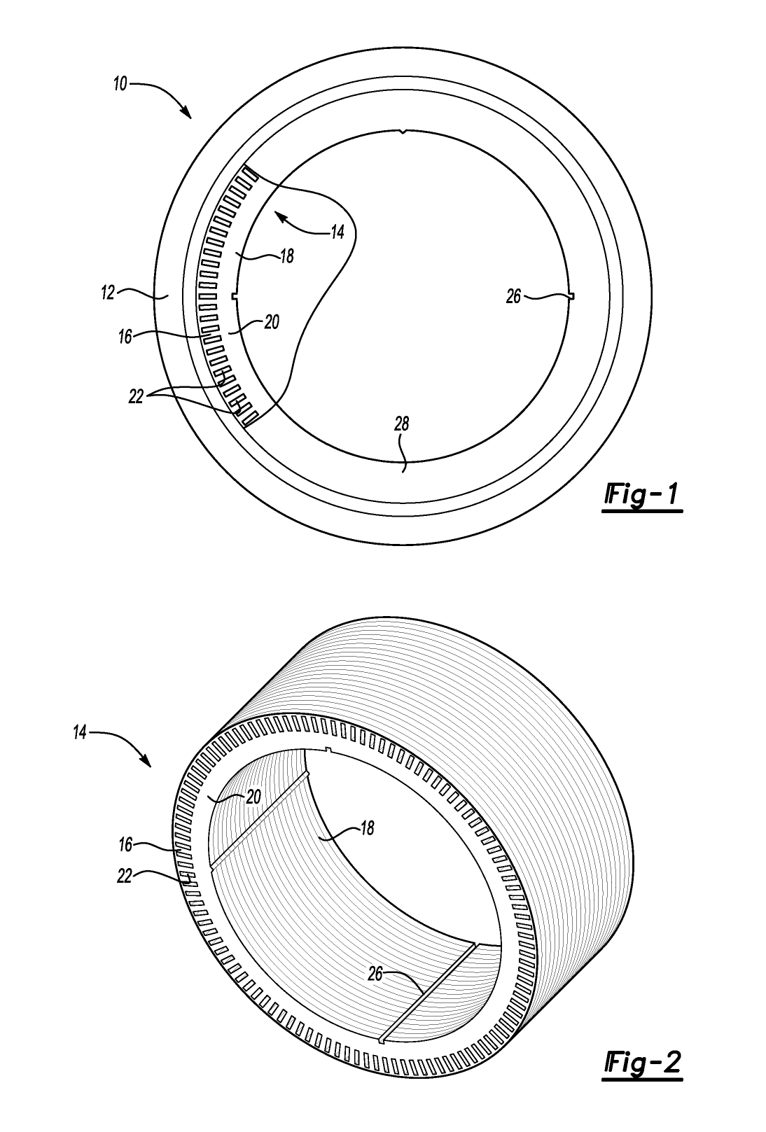

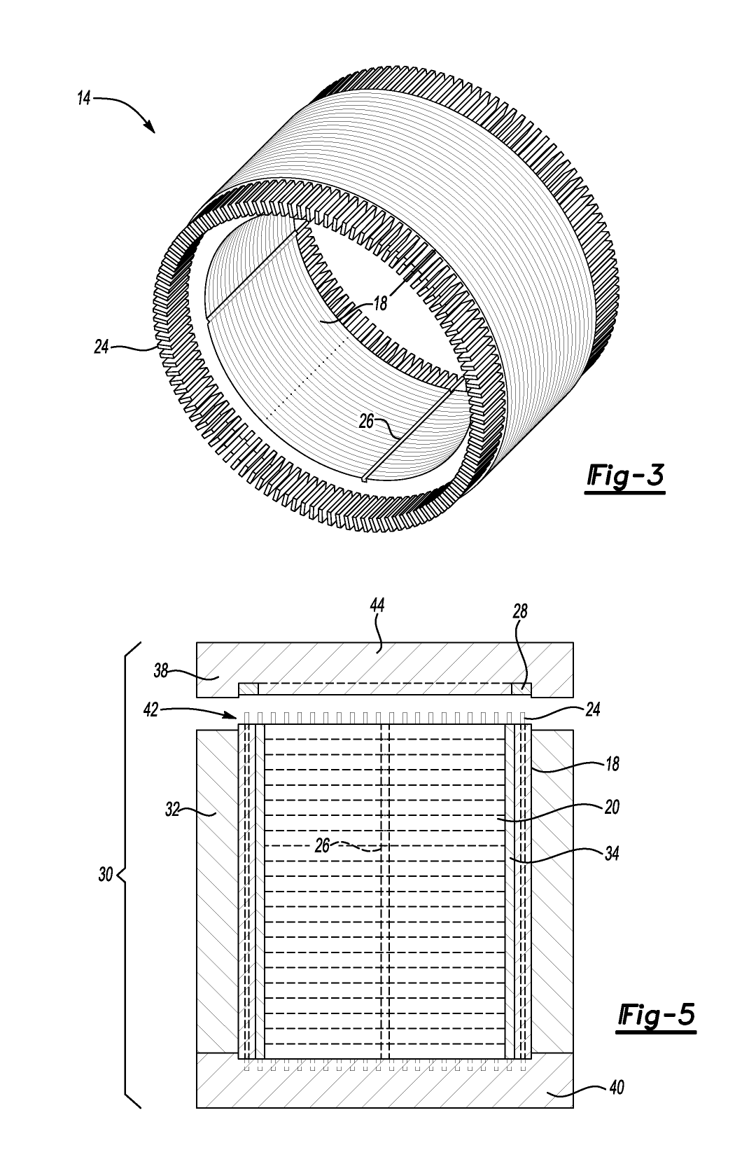

Referring to the Figures, wherein like reference numbers refer to the same or similar components throughout the several views, FIG. 1 partially schematically illustrates an electric motor 10 having a stator assembly 12 and a rotor assembly 14. The rotor assembly 14 includes a rotor stack 18. The rotor stack 18 is formed from a stack of laminate layers 20. A plurality of rotor teeth 16 extend radially outward from the rotor stack 18. The rotor teeth 16 are spaced apart from one another and formed on each of the laminate layers 20. The laminate layers 20 are placed together to form the rotor stack 18 and the spaced apart rotor teeth 16 form rotor slots 22. A plurality of conductors or conductor bars 24 may be inserted within the rotor slots 22 (shown in FIG. 3). An end piece 28 is located at each axial end of the rotor stack 18.

FIGS. 2 and 3 illustrate the rotor stack 18 that is formed from the laminate layers 20. Each of the laminate layers 20 has rotor teeth 16 spaced to define the rotor slots 22. The laminate layers 20 are stacked together to form a rotor stack 18 at the predetermined height, as shown. Alignment features 26 formed on the inner annular edge of each laminate layer 20 assist in aligning the laminate layers 20 with one another during the assembly process and ensure that the rotor slots 22 in each laminate layer 20 are properly aligned with one another. In the embodiment shown, the alignment features 26 can be grooves or tabs, protruding from each of the laminate layers 20. When the laminate layers 20 are assembled into the rotor stack the alignment features 26 form grooves, or protrusions extending the axial length of the rotor stack 18. In the embodiment shown, the alignment features 26 also function as hub mating features. The hub mating features are located on the inner annular surface of the rotor stack 18, and may be used to align the rotor stack 18 with a hub (not shown) when the electric motor 10 is assembled.

As illustrated in FIG. 3, once the laminate layers 20 are assembled to form the rotor stack 18 to the desired height, the conductor bars 24 are then inserted within the rotor slots 22. Each of the conductor bars 24 protrudes from the rotor stack 18 at the axial ends, as shown. The conductor bars 24 may axially protrude from the rotor stack 18 for only several millimeters. The distance the conductor bars 24 protrude from the rotor stack 18 can vary from one electric motor 10 to another depending on the dimensions of the rotor end pieces 28 (shown in FIG. 5) and the conductor bars 24. One skilled in the art would be able to determine the amount of protrusion that is desired for a particular electric motor 10.

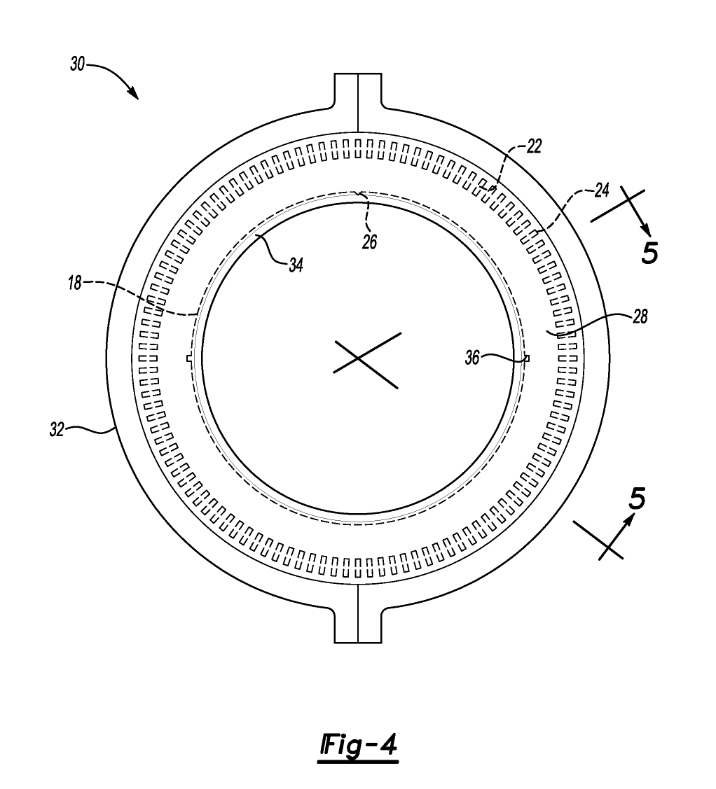

Referring to FIGS. 4 and 5, an annularly shaped end piece 28 is welded on each axial end of the rotor stack 18. The end pieces 28 are located such that the end pieces 28 abut the axial ends of the conductor bars 24. The end pieces 28 must be fixed to the conductor bars 24 to allow conductivity between the conductor bars 24 and the end pieces 28 in order to properly operate the electric motor 10. In the embodiment described below, spin welding is utilized to secure the end pieces 28 and the conductor bars 24 to one another.

The rotor stack 18, conductor bars 24, and end pieces 28 are placed in a weld fixture 30, as illustrated in FIGS. 4 and 5. The end pieces 28 and the plurality of conductor bars 24 are rotated at high velocity relative to one another to create a welded bond, which will be generally located at 42. The relative velocity between the end pieces 28 and the conductor bars 24 and the axial force on the end pieces 28 while welding will depend on the dimensions of the end pieces 28 and the conductor bars 24, amount of protrusion of the conductor bars 24 from the rotor stack 18, as well as the type of material, e.g. copper, aluminum alloy, etc., forming the end pieces 28 and the conductor bars 24.

As explained in further detail below, the end pieces 28 may be attached one at a time, or simultaneously with one another. To attach the end pieces 28 one at a time, the plurality of conductor bars 24 may be secured in the weld fixture 30. One end piece 28 is rotated and moved into contact with the ends of the conductor bars 24 by the weld fixture 30 with an axially applied load. The rotor stack 18, conductor bars 24 and first end piece 28 are then removed from the weld fixture 30, rotated and secured in the weld fixture 30 again, such that the opposing end piece 28 could be welded onto the other ends of the conductor bars 24 in the same manner. Alternatively, the rotor stack 18 and conductor bars 24 are held by the weld fixture 30 between both of the end pieces 28 which are rotated and then moved toward one another at the opposing ends of the rotor stack 18, in order to generally simultaneously weld the two end pieces 28. The end pieces 28 can be rotated in the same direction or rotated counter to one another.

The rotor stack 18 and the conductor bars 24 are secured in the weld fixture 30 during the weld process. The alignment features 26 (shown in FIG. 3) may assist in aligning and securing the rotor stack 18 during the weld process. The weld fixture 30 may include a first fixture component, such as an outer fixture element 32, an inner fixture element 34 or both. The weld fixture 30 secures the rotor stack 18 about the radial exterior and/or interior of the rotor stack 18 to allow access to the axial ends of the protruding conductor bars 24 during the weld process. That is, the first component of the weld fixture 30 secures the rotor stack 18 at the inner annular surface and/or the outer annular surface of the laminate layers 20 to prevent rotation.

The first fixture component, i.e. at least one of the outer fixture element 32 and/or the inner fixture element 34 is used to hold the rotor stack 18 stationary, with respect to the weld fixture 30. The alignment features 26 may be located on the inner or outer annular surface of the rotor stack 18. Matching fixture alignment features 36 (shown in FIG. 4) are located on the corresponding outer fixture element 32 and/or inner fixture element 34. The rotor alignment features 26 and the fixture alignment features 36 mate together to prevent relative rotation between the weld fixture 30 and the rotor stack 18. Additionally, the first fixture component, i.e. outer fixture element 32 and/or inner fixture element 34, may apply a slight compressive force to the rotor stack 18 to increase the static friction between the rotor stack 18 and the first fixture component, i.e. outer fixture element 32 and/or inner fixture element 34, to assist in preventing relative rotation.

A second fixture component 44 secures one of the end pieces 28 to be welded to the conductor bars 24 and a third fixture component 40 secures an opposing end of the rotor stack 18. The third fixture component 40 is used to apply pressure and maintain alignment of the rotor stack 18, conductor bars 24 and end pieces 28. The third fixture component 40 may define slots for receiving the protruding axial ends of the conductor bars 24 and assist in maintaining alignment of the conductor bars 24.

The second fixture component 44 may be used to secure one of the end pieces 28 and apply lateral pressure to the rotor end piece 28 during the weld process. The second fixture component 44 may at least partially surround the end piece 28 on an inner surface of the end piece 28 and an outer surface of the end piece 28, as shown. Additionally, portion 38 of the second fixture component 44 may extend further than the end piece 28 and be configured to align with the first fixture component, i.e. outer fixture element 32 and/or inner fixture element 34, which may be slightly recessed relative to the axial end of the rotor stack 18. Illustrated in the embodiment shown in FIG. 5, the outer fixture element 32 is slightly recessed and the second fixture component 44 has a protrusion at the portion 38. The alignment of the portion 38 and the outer fixture piece 32 may assist in maintaining the axial alignment between the end piece 28 and the conductor bars 24.

To weld the end piece 28 to the conductor bars 24 one of the end pieces 28 or the rotor stack 18 is rotated relative to the other and a lateral load is applied by the weld fixture 30 to bring the end piece 28 and the conductor bars 24 into contact, generating friction along the mating interface, shown generally at 42. The relative rotation between the conductor bars 24 and the end piece 28 results in spin welding the conductor bars 24 and the end piece 28 together.

The end pieces 28 may be welded to each end of the rotor stack 18 one at a time. When the end pieces 28 are welded one at a time, one of the end pieces 28 is secured with the second fixture component 44. The rotor stack 18 is secured with the first fixture component, i.e. outer fixture element 32 and/or inner fixture element 34. The conductor bars 24 at the opposing end that is being welded are received by the third fixture component 40. The third fixture component 40 is also used to apply pressure and maintain alignment of the rotor stack 18, conductor bars 24 and end pieces 28. Either the end piece 28 is rotated with the second fixture component 44 or the rotor stack 18 and conductor bars 24 are rotated with the first fixture component, i.e. inner fixture element 34 and/or outer fixture element 32. Additionally, the second fixture component 44 applies a lateral force on the end piece 28 toward the axial ends of the conductor bars 24.

Relative rotation between the end pieces 28 and the conductor bars 24 produces enough heat to the heat end piece 28 and then the axial motion (applied by the weld fixture 30) forges them together and generates an upset, such that the relative motion will forge or “weld” the end piece 28 and conductor bars 24. The weld fixture 30 then stops rotating. The end piece 28 and/or the conductor bars 24 are cooled and a weld bond 42 is formed therebetween.

The welded end piece 28 and conductor bars 24 are removed from the weld fixture 30 and rotated. Then the opposing end piece 28 is welded in the same manner as described above. Securing the end piece 28 to the rotor stack 18 may require only minimal or no further processing to remove additional material after the weld process is complete.

Alternately, the end pieces 28 may be welded to the conductor bars 24 generally simultaneously with one another. The rotor stack 18 may be secured in the weld fixture 30 by the first fixture component, i.e. outer fixture element 32 and/or inner fixture element 34. The third fixture component 40 may have an identical appearance to the second fixture component 44. That is, the third fixture component 40 may have the same appearance as second fixture component 44 of FIG. 5. Each of the second fixture component 44 and the third fixture component 40 would secure one of the end pieces 28 at opposing axial ends of the rotor stack 18. The second fixture component 44 and the third fixture component 40 may be rotated and apply lateral force to move the end pieces 28 toward the rotor stack 18 to weld the end pieces 28 to the conductor bars 24 generally simultaneously. The second fixture component 44 and the third fixture component 40 may be rotated in the same direction as one another, or in opposing directions.

Additionally, as described in the embodiment shown in FIGS. 4 and 5, spin welding may be utilized on a high volume basis having consistent efficiency. When utilizing spin welding to attach the end piece 28 to the rotor stack 18, the end piece 28 may be formed from any alloys that have sufficient conductivity and strength for operation of the electric motor 10. End pieces 28 are formed from the desired material prior to the welding process and the weld bond 42 between the end pieces 28 and the conductor bars 24 generally provides good conductivity and density. Any materials that can withstand the spin welding process while providing sufficient conductivity for the operation of the electric motor 10 may be utilized for the end pieces 28 and for the conductor bars 24. One skilled in the art would be able to determine the desired material for the end pieces 28 and the conductor bars 24.

While the best modes for carrying out the invention have been described in detail, those familiar with the art to which this invention relates will recognize various alternative designs and embodiments for practicing the invention within the scope of the appended claims.

1. A method of manufacturing an electric motor comprising:
stacking a plurality of laminate layers to form a rotor stack, wherein the rotor stack defines a plurality of rotor slots;
inserting a plurality of conductor bars into the plurality of rotors slots such that axial ends of each of the conductor bars protrudes from the axial ends of the rotor stack; and
rotating one of the rotor stack and end pieces for the electric motor to weld the end pieces to the axial ends of the plurality of conductor bars.

2. The method of claim 1, wherein rotating one of the rotor stack and the end pieces further comprises generally simultaneously rotating a respective one of the end pieces at each respective axial end of the rotor stack.

3. The method of claim 2, wherein the generally simultaneously rotating further includes rotating one of the end pieces in a first direction and rotating the other of the end pieces in a second opposing direction.

4. The method of claim 1, wherein rotating one of the rotor stack and the end pieces further comprises rotating one of the end pieces at one end of the rotor stack and then rotating the other of the end pieces at the opposing end of the rotor stack.

5. The method of claim 1, wherein rotating one of the rotor stack and the end pieces further comprises rotating one of the end pieces relative to one end of the rotor stack, repositioning the rotor stack within the weld fixture, and rotating the other of the end pieces relative to the opposing end of the rotor stack.

6. The method of claim 1 further comprising, placing the rotor stack in a weld fixture after inserting the plurality of conductor bars into the plurality of rotor slots.

7. The method of claim 1 further comprising, securing the rotor stack in a weld fixture by matching alignment features on at least one of an inner annular surface and an outer annular surface of the rotor stack with corresponding alignment features on at least one of an inner weld fixture and an outer weld fixture.

8. A method of securing an end piece to a plurality of conductor bars for an electric motor comprising:
securing a rotor stack having a plurality of axially protruding conductor bars to at least a first component of a weld fixture;
securing a first end piece to at least a second component of the weld fixture, such that the first end piece aligns with the axial end of the plurality of conductor bars;
rotating one of the first component and the second component of the weld fixture to rotate the first end piece and the plurality of conductor bars relative to one another; and
applying lateral force on the first end piece such that a weld bond is formed between the first end piece and the plurality of conductor bars.

9. The method of claim 8, further comprising:
securing a second end piece to at least a third component of the weld fixture, such that the second end piece aligns with the axial end of the plurality of conductor bars opposing the first end piece;
rotating one of the first component and the third component of the weld fixture to rotate the second end piece and the plurality of conductor bars relative to one another; and
applying lateral force on the third end piece such that a weld bond is formed between the third end piece and the plurality of conductor bars.

10. The method of claim 9, further comprising rotating the second component generally simultaneously with rotating the third component.

11. The method of claim 9, further comprising rotating the second component in one direction and the third component in an opposing direction.

12. The method of claim 8, wherein securing the rotor stack to the first component of the weld fixture further includes matching alignment features on at least one of an inner annular surface and an outer annular surface of the rotor stack with corresponding alignment features on the first component weld fixture.
